(19) United States
(12) Patent Application Publication
(10) Pub. No.: US 2006/0085531 A1
(43) Pub. Date: Apr. 20, 2006

(54) Active data transmission device and system

(75) Inventors: Ying-Chieh Lei, Kaohsiung City (TW); Fu-Ming Shih, Tainan City (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/023,573

(22) Filed: Dec. 29, 2004

(30) Foreign Application Priority Data
Oct. 15, 2004 (TW) 093131414

(51) Int. Cl. G06F 15/173

(52) U.S. Cl. 709/223

(57) ABSTRACT

The present invention provides an active data transmission device and system. In the system, a portable electronic image-capturing/data-storage device is stored with data. An active data transmission device is connected to the portable electronic image-capturing/data-storage device for actively reading the data therein. A network server provides a dedicated storage space for the active data transmission device, wherein the active data transmission device is linked to the network server via a network for storing the read data.

### BACKGROUND OF THE INVENTION

1. Field of the Invention

The present invention relates to an active data transmission device and system, and more particularly, to an active data transmission device and system capable of providing data sharing via network transmission.

2. Description of Related Art

With the popularity of portable electronic image-capturing devices, such as digital cameras and digital videos (DVs), more and more people get used to use such kind of portable electronic image-capturing devices to record their life. However, the conventional portable electronic image-capturing device has limitation in its memory capacity. Generally, the portable electronic image-capturing device utilizes its build-in memory or an inserted memory card to provide memory capacity for storing photos or video files. While the user keeps using the portable electronic image-capturing device to take photos or record videos, it becomes out of memory capacity shortly. Consequently, the user has to remove those photos or video files to another computer device, such as a personal computer or a notebook computer, or exchange another memory card so as to continue photographing or videotaping. In this regard, it is quite inconvenient for common use. Especially when the user travels outdoors, he/she has to carry about the notebook or additional memory cards, otherwise, he/she cannot continue photographing or videotaping once the portable electronic image-capturing device doesn't have enough memory capacity left.

In general, the portable electronic image-capturing device can be accessed through a card reader for reading image data from the memory card, or via a USB connection so as to connect the portable electronic image-capturing device with a computer device for transmitting photos or video files to the memory of the computer device via the connection. In the way of reading image data from the memory card by using the card reader, the memory card should be taken out from the portable electronic image-capturing device first, and then inserted in the card reader. Furthermore, the card reader cannot access the image data unless connecting to the computer. However, there are various kinds of memory card standards, including Compact Flash (CF) cards, Smart Media (SM) cards, Memory Stick (MS) cards, MultiMedia cards (MMC), extreme Digital (XD) cards, and etc., wherein each memory card standard is not compatible with one another. Therefore, it is very inconvenient for the user to select different card readers to comply with different memory card standards corresponding to the portable electronic image-capturing devices.

On the other hand, the way of transmitting photos or video files from the portable electronic image-capturing device to the computer device via the USB connection for storage purpose can eliminate the problem of various kinds of card standards. However, in the USB system, the general digital camera or digital video is regarded as a client, which has to connect to a host such as a personal computer, otherwise it cannot function. That is, the digital camera or digital video cannot connect to other devices for transmitting data other than the USB host. For example, the digital camera or digital video cannot transmit data via a wireless network by connecting to a wireless card, therefore causing the limitation of usage. Please refer to FIG. 1, the user still has to use the computer 12 as a referral device to help upload photos or video files of the portable electronic image-capturing device 11 to the network 13. In order to reduce the complexity of manipulation, please refer to FIG. 2, a base 14 with a USB interface is provided for connecting with the computer 12, such that photos or video files can be easily uploaded to the network 13 by operating the button of the base 14 as long as the portable electronic image-capturing device 11 is placed on the base 14. However, this implementation still has to use a computer 12 as a referral device.

Moreover, usually the photos or video files captured by the portable electronic image-capturing device are those ones that the user is eager to share with relatives and friends during a journey. However, since the portable electronic image-capturing device cannot just connect with the wireless card for directly transmitting those photos or video files via the wireless network, those photos or video files would only be exhibited after the journey, while the sense of novelty has no longer exists. As a result, it is desirable that the photos or images captured by the portable electronic image-capturing device can be transmitted to the relatives or friends without using a computer.

Therefore, it is desirable to provide an improved active data transmission device and system to mitigate and/or obviate the aforementioned problems.

### SUMMARY OF THE INVENTION

The object of the present invention is to provide an active data transmission device and system, which immediately transmits data of a portable electronic image-capturing device to the network for providing data sharing without using a computer.

In accordance with one aspect of the present invention, the active data transmission system of the present invention includes a portable electronic image-capturing/data-storage device, an active data transmission device, and a network server. The portable electronic image-capturing/data-storage device is stored with data. The active data transmission device is connected to the portable electronic image-capturing/data-storage device for actively reading the data therein. The network server provides a dedicated storage space for the active data transmission device, wherein the active data transmission device is linked to the network server via a network for storing the read data.

According to another aspect of the present invention, the active data transmission device of the present invention is capable of transmitting data stored in a portable electronic image-capturing/data-storage device to a network server. The active data transmission device includes a data transmission module, a user identification module, a network transmission module, and a control module. The data transmission module is used for connecting to the portable electronic image-capturing/data-storage device. The user identification module is stored with link creation and login data for connecting to the network. The network transmission module is used for connecting to the network. The control module controls the operation of the aforementioned modules. Further, the control module creates a link and login the network server according to the link creation and login data of the user identification module, reads the data stored in the portable electronic image-capturing/data-storage device via the network transmission module, and transmits the read data to the network server via the network transmission module for storing the read data.

Other objects, advantages, and novel features of the invention will become more apparent from the following detailed description when taken the accompanying drawings.

### BRIEF DESCRIPTION OF THE DRAWINGS

FIG. 1 illustrates a conventional structure of uploading photos or video files of a portable electronic image-capturing device to the network;

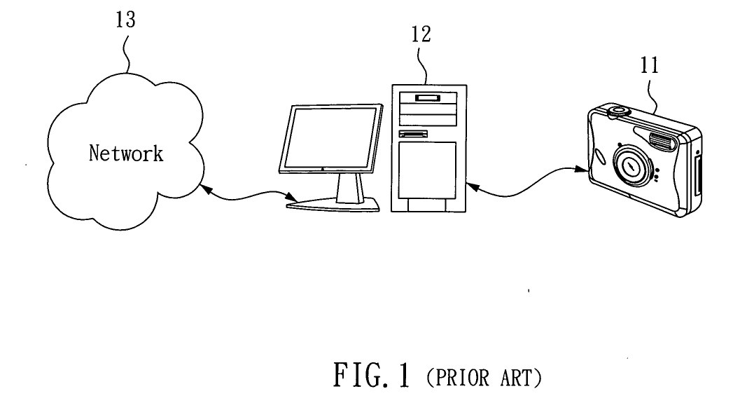

FIG. 2 illustrates an improved conventional structure of uploading photos or video files of a portable electronic image-capturing device to the network;

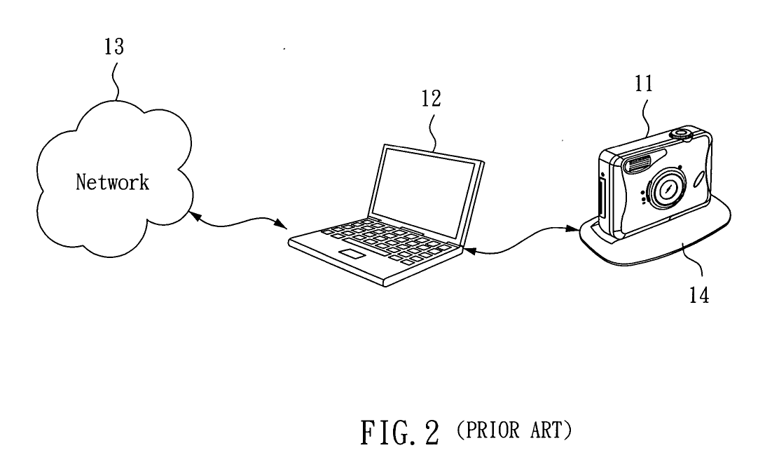

FIG. 3 is a schematic drawing of the active data transmission system according to the present invention;

FIG. 4 is a block diagram of the active data transmission device according to the present invention;

FIG. 5 is a flowchart of transmitting data stored in the portable electronic image-capturing/data-storage device to the network according to the active data transmission device of the present invention; and

FIG. 6 depicts various applications executed after transmitting data to the network server according to the active data transmission device of the present invention.

### DETAILED DESCRIPTION OF THE PREFERRED EMBODIMENT

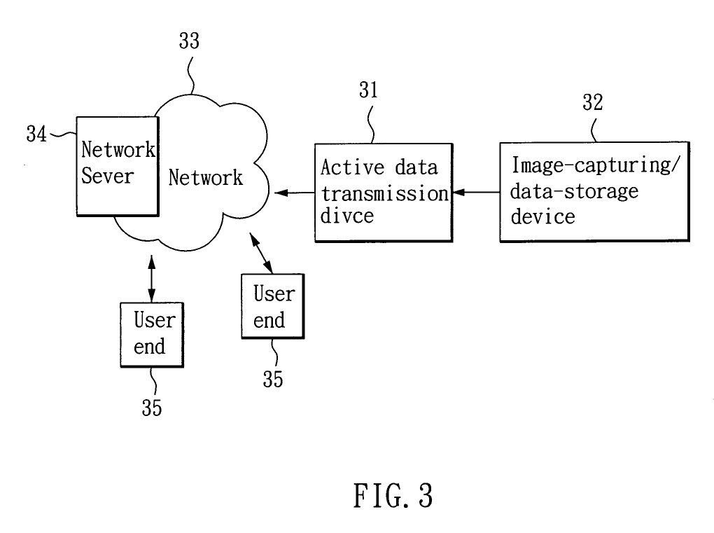

Please refer to FIG. 3. FIG. 3 is a schematic drawing of the active data transmission system according to the present invention. An active data transmission device 31 is connected to a portable electronic image-capturing/data-storage device 32 via a standard transmission interface. The portable electronic image-capturing/data-storage device 32 is preferred to be a digital photo frame, a digital album, a portable hard disk, a digital camera, a digital video or a USB drive, which is stored with photos, images, video files, text files or the like. The active data transmission device 31 transmits the data stored in the portable electronic image-capturing/data-storage device 32 to the network server 34 for a network storage purpose via the network 33. Such that other user ends 35 can share the data or process the data for providing a further service by connecting to the network server 34 via the network 33.

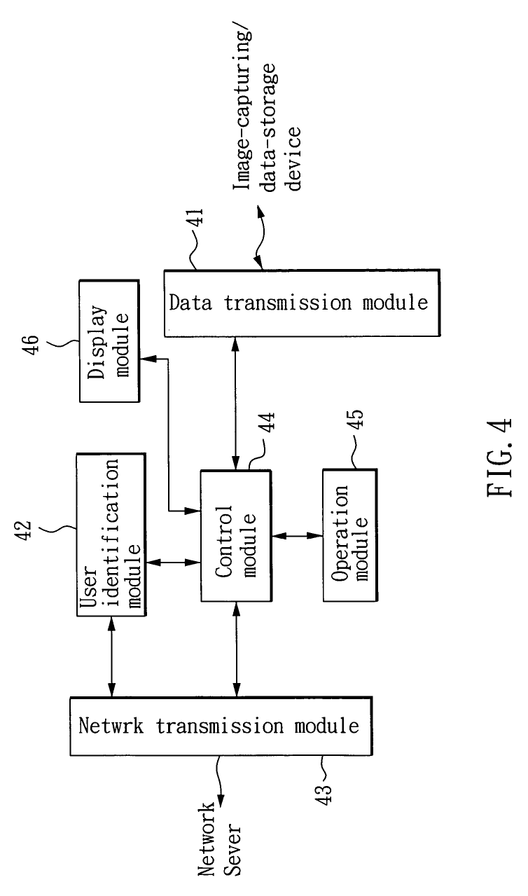

With reference to FIG. 4, FIG. 4 is a block diagram of the aforementioned active data transmission device 31, which includes a data transmission module 41, a user identification module 42, a network transmission module 43, a control module 44, an operation module 45 and a display module 46. The data transmission module 41 is used for connecting to the portable electronic image-capturing/data-storage device 32, wherein the data transmission module 41 can be a USB host, an IEEE 1394 host, and a Bluetooth host. The user identification module 42 is pre-stored with creation and login data for connecting to the network. The creation and login data comprises: network linkage parameters such as Internet Service Provider (ISP) data and linkage accounts; and network server parameters such as the address of the network server to be transmitted and authentication information of the network server. The network transmission module 43 is preferably a wired or wireless Ethernet device or a wireless WiFi/WiMax transmission device for connecting to the network 33. The operation module 45 has buttons for operating the active data transmission device 31. The display module 46 is a display device capable of displaying the operation status of the active data transmission device 31.

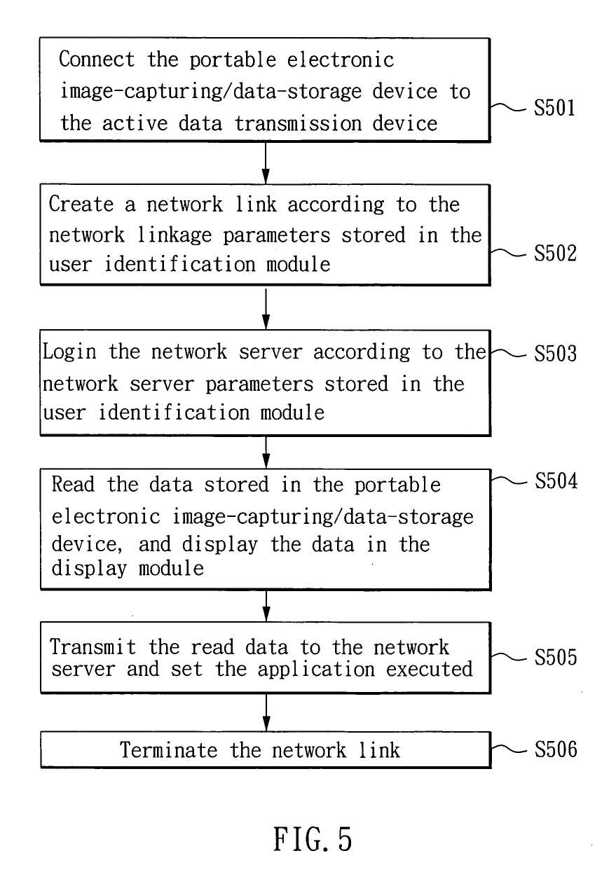

According to the above active data transmission device 31, the data stored in the portable electronic image-capturing/data-storage device 32 can be transmitted to the network 33 for data-sharing or further processing. Please refer to FIG. 5, FIG. 5 illustrates the flowchart of an embodiment of the present invention. At first, the user connects the portable electronic image-capturing/data-storage device 32 to the data transmission module 41 of the active data transmission device 31 (S501). Therefore, the user activates the active data transmission device 31 for processing network linkage and transmitting data by operating the operation module 45. In the meantime, the control module 44 controls the network transmission module 43 to create a network link according to the network linkage parameters stored in the user identification module 42 (S502). After the network link is successfully created, the control module 44 processes a login procedure according to the network server parameters stored in the user identification module 42 to login the network server 34 (S503). After completing the login procedure, the network server 34 configures a dedicated or non-dedicated storage space for the active data transmission device 31. Then, the control module 44 controls the data transmission module 41 to read the data stored in the portable electronic image-capturing/data-storage device 32, and further displays the data in the display module 46 for user review (S504). The display module 46 can simply display the file names of the data, or performs a preview of the data. Accordingly, the user then operates the operation module 45 to transmit the read data to the dedicated or non-dedicated storage space of the network server 34. The user can further set the application executed after transmitting the data to the network server 34, such that the application setting signal can also be transmitted to the network server 34 (S505). After finishing transmitting, the control module 44 terminates the network link (S506) with the network server 34 stored with the data, and the network server 34 can then process a post-procedure according to the application setting signal.

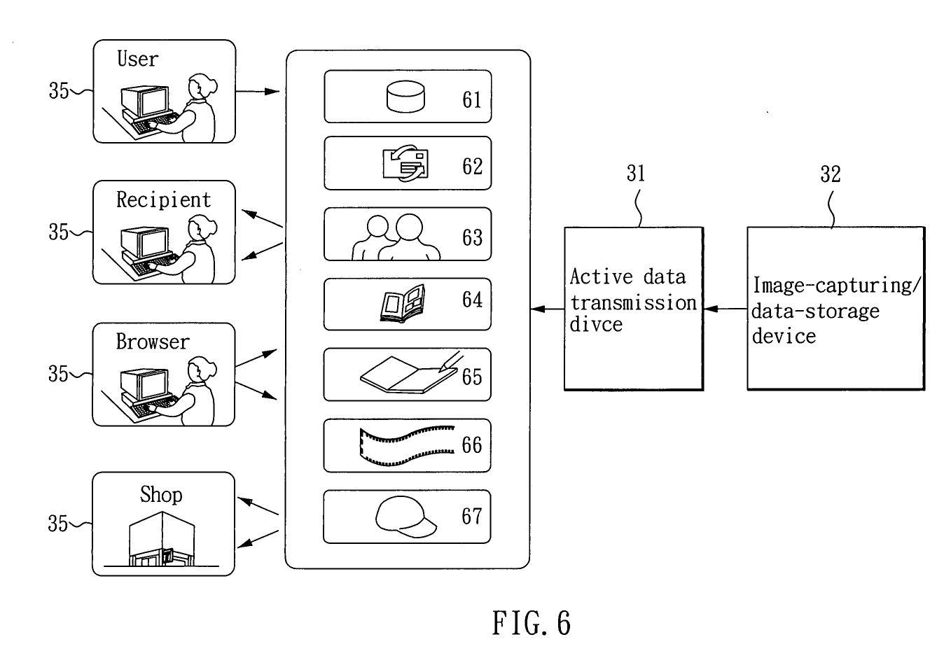

FIG. 6 further depicts the various applications executed after transmitting the data stored in the portable electronic image-capturing/data-storage device 32 to the network server 34. These applications includes a network backup/hard-disk application 61, an email forwarding application 62, an instant message transmission and short message notification/transmission application 63, a network photo album application 64, a blog application 65, an on-line photo printing application 66, and a personalized product making application 67. The network backup/hard-disk application 61 is used for storing the transmitted file data in the network server 34, and providing data-sharing so as to enable other user ends 35 to read the stored file data. The email forwarding application 62 is used for storing the transmitted email data in the network server 34, and forwarding the email data to the recipient of the client 35. The real-time message transmission and short message notification/transmission application 63 is used for storing the transmitted real-time message data or shot message data in the network server 34, and transmitting it to the recipient of the user end 35. The network photo album application 64 is used for storing the transmitted photo data in the network server 34, such that browsers of other user ends 35 are capable of browsing the photo data. The blog application 65 is used for storing transmitted video/audio data in the network server 34, such that browsers of other clients 35 are capable of browsing the video data. The on-line photo printing application 66 is used for storing the transmitted photo data in the network server 34 so as to transmit the photo data to the shop of the user end 35 for printing out physical photos. The personalized product making application 67 is used for storing the transmitted image data in the network server 34 so as to transmit the image data to the shop of the user end 35 for making products with personalized images.

In view of the foregoing, it is known that the active data transmission device of the present invention can actively read data stored in the portable electronic image-capturing/data-storage device through the data transmission module, and transmit the read data to the network server via a wired or wireless network transmission module by utilizing the user identification module. Consequently, the problem of memory capacity limitation of the portable electronic image-capturing/data-storage device can be eliminated. Further, the purpose of sharing video/audio data can be implemented according to the present invention.

Although the present invention has been explained in relation to its preferred embodiment, it is to be understood that many other possible modifications and variations can be made without departing from the spirit and scope of the invention as hereinafter claimed.

What is claimed is:

1. An active data transmission system, comprising:
a portable electronic image-capturing/data-storage device stored with data;
an active data transmission device connected to the portable electronic image-capturing/data-storage device for actively reading the data stored in the portable electronic image-capturing/data-storage device; and
a network server for providing a storage space for the active data transmission device;
wherein the active data transmission device is linked to the network server via a network for storing the data read from the portable electronic image-capturing/data-storage device.

2. The system as claimed in claim 1, wherein the network server further shares the data with other user ends.

3. The system as claimed in claim 1, wherein the network server further provides a predetermined application according to the data.

4. The system as claimed in claim 3, wherein the predetermined application is selectively to be a network backup/hard-disk application, an email forwarding application, a real-time message transmission and short message notification/transmission application, a network photo album application, a blog application, an on-line photo printing application, and a personalized product making application.

5. The system as claimed in claim 1, wherein the active data transmission device comprises:
a data transmission module for connecting to the portable electronic image-capturing/data-storage device;
a user identification module stored with link creation and login data for connecting to the network;
a network transmission module for connecting to the network; and
a control module for controlling the operation of the data transmission module, the user identification module, and the network transmission module, such that the control module creates a link and login the network server according to the link creation and login data of the user identification module, reads the data stored in the portable electronic image-capturing/data-storage device via the data transmission module, and transmits the read data to the network server via the network transmission module for storing the read data.

6. The system as claimed in claim 5, wherein the link creation and login data stored in the user identification module comprises network linkage parameters and network server parameters.

7. The system as claimed in claim 6, wherein the control module creates a link via the network transmission module according to the network linkage parameters, and logins to the network server according to the network server parameters after the link is successfully created.

8. The system as claimed in claim 1, wherein the network server configures a dedicated storage space for the active data transmission device.

9. The system as claimed in claim 5, wherein the network server configures a dedicated storage space for the active data transmission device.

10. An active data transmission device for transmitting data stored in a portable electronic image-capturing/data-storage device to a network server, the active data transmission device comprising:
a data transmission module for connecting to the portable electronic image-capturing/data-storage device;
a user identification module stored with link creation and login data for connecting to the network;
a network transmission module for connecting to the network; and
a control module for controlling the operation of the data transmission module, the user identification module, and the network transmission module, such that the control module creates a link and login the network server according to the link creation and login data of the user identification module, reads the data stored in the portable electronic image-capturing/data-storage device via the data transmission module, and transmits the read data to the network server via the network transmission module for storing the read data.

11. The device as claimed in claim 10, wherein the control module further sets an application executed after transmitting the data to the network server, and transmits an application setting signal of the application to the network server such that the network server implements a corresponding process according to the application setting signal.

12. The device as claimed in claim 10, wherein the link creation and login data stored in the user identification module comprises network linkage parameters and network server parameters.

13. The device as claimed in claim 12, wherein the control module creates a link via the network transmission module according to the network linkage parameters, and logins to the network server according to the network server parameters after the link is successfully created.

14. The device as claimed in claim 10, further comprising an operation module for operating the active data transmission device.

15. The device as claimed in claim 10, further comprising a display module for displaying an operation status of the active data transmission device.

16. The device as claimed in claim 10, wherein the data transmission module is selectively to be a USB host, an IEEE 1394 host, and a Bluetooth host.

17. The device as claimed in claim 10, wherein the network transmission module is selectively to be a wired or wireless Ethernet device, and a wireless WiFi transmission device.

18. The device as claimed in claim 10, wherein the network server stores the read data in a dedicated storage space.
